(19) United States
(12) Patent Application Publication
(10) Pub. No.: US 2006/0125743 A1
(43) Pub. Date: Jun. 15, 2006

(54) LCD panel driving device and conductive pattern on LCD panel therefore

(75) Inventors: Won Kee Lee, Anyang-si (KR); Sung Hwi Park, Anyang-si (KR)

Correspondence Address: BRUCE E. LILLING;LILLING & LILLING P.C., P.O. BOX 560, GOLDEN BRIDGE, NY, 10526, US

(73) Assignee: Displaychips Inc., Anyang-si (KR)

(21) Appl. No.: 11/289,222

(22) Filed: Nov. 29, 2005

(30) Foreign Application Priority Data
Dec. 1, 2004 (KR) 10-2004-0099797

(51) Int. Cl. G09G 3/30

(52) U.S. Cl. 345/80

(57) ABSTRACT

Disclosed relates to an LCD panel driving device that improves power input ends for inputting driving signals and connection patterns of the LCD panel driving device and the LCD panel, thus eliminating a block dim phenomenon generated when driving the LCD panel. The LCD driving device connected electrically with conductive patterns formed on a lower glass of an LCD and outputting driving signals for driving the LCD panel based on driving signals input from the conductive patterns, the LCD driving device of the invention comprising: a plurality of first input bumps for inputting driving signals; and a plurality of second input bumps coupled electrically with the first input bumps, respectively, at least two of the first input bumps being connected with each other via resistors having at least two different resistance values.

### BACKGROUND OF THE INVENTION

1. Field of the Invention

The present invention relates to a driving circuit for driving a liquid crystal display (LCD) panel and, more particularly, to an LCD panel driving device that improves power input ends for inputting driving signals and conductive patterns on the LCD panel that are modified suitable for being adapted to the LCD panel driving device, thus eliminating a block dim phenomenon occurring when driving the LCD panel.

2. Description of the Related Art

In general, a liquid crystal display LCD, especially a Thin Film Transistor TFT LCD has been widely used owing to its various merits that it is thin in thickness and light in weight, and it needs lower power consumption and is readily fabricated in larger sizes. FIG. 1 is a configuration diagram showing a general module of a conventional TFT LCD commonly used. Reference numerals 1 and 2 denote a lower glass and an upper glass, respectively, constituting an LCD panel. Numeral 3 denotes a printed circuit board PCB for applying driving power sources, gate driving signals and data driving signals to the lower glass 1. The PCB 3 includes a DC-DC converter 301, a controller 302 and a plurality of driving devices.

The PCB 3 and the lower glass 1 are coupled electrically and physically with each other by means of specific connecting members 4 made of soft films. The connecting member 4 has a data driving device 401 mounted thereon in a flip chip method, for example, and a plurality of conductive patterns, not shown. The conductive patterns apply the data output from the PCB 3 electrically to the data driving device 401 and the data driving signals output from the data driving device 401 electrically to data lines (not shown) formed on the lower glass 1.

Meanwhile, the gate driving signal applied from the PCB 3 is input to the lower glass 1 via at least one of the plural connecting members 4 and connected electrically with a base film 5 via a gate signal conductive pattern 11 formed on the lower glass 1.

The base film 5 made of the same soft material as the connecting member 4 includes a gate driving device 51 mounted in a flip chip method and a conductive pattern 52 for electrically coupling the conductive pattern 11 on the lower glass 1 with the gate driving device 51.

Gate driving signals of the liquid crystal panel include electric power sources such as VDD (2.5˜5V), VSS (0V), VGH (+15˜+30V), etc., and signals such as CLK, DIO1, DIO2, OE, DIR, etc. Since the gate driving signals are used commonly by the respective gate drive devices 51, the gate drive device 51 re-outputs the gate driving signals to apply them to a following gate drive device 51.

FIG. 2 is a configuration diagram illustrating how the base films 5 and the lower glass 1 are connected, each base film 5 having the gate driving device 51 of FIG. 1. The gate driving signals are connected with a first conductive pattern 52-1 formed on a first base film 5-1 via a conductive pattern 11-1 arranged on the lower glass 1. Then, the driving signals are applied to an internal circuit of a first gate driving device 51-1 via a first input bump 511-1 of the first gate driving device 51-1. The driving signals input to the first input bump 511-1 are applied via a second input bump 511-2 and a second conductive pattern 52-2 formed on the first base film 5-1 to a conductive pattern 11-2 on the lower glass 1.

The driving signals connected to the conductive pattern 11-2 are applied to a first input bump 511-1 of a second gate driving device 51-2 via a first conductive pattern 52-3 on a base film 5-2 in the same manner with the first base film 5-1. Then the driving signals input to the first input bump 511-1 are applied to an internal circuit of the second gate driving device 51-2 and, at the same time, output again via the second input bump 511-2. The driving signals output from the second input bump 511-2 are applied via a second conductive pattern 52-4 on the base film 5-2 and a conductive pattern 11-3 on the lower glass 1 to a following gate driving device.

However, in the method that the driving signals are connected in series with the gate driving devices 51 in turn, electric potentials of the driving signals are gradually decreased as passing through the gate driving devices 51 due to sheet resistances that the conductive pattern 511 formed on the base film 5 and the conductive pattern 11 on the lower glass 1 have. That is, the levels of the driving signals applied to the respective driving device 51 may be varied, which consequently causes differences between the driving voltages supplied from the gate driving devices 51 to the LCD panel, thus generating brightness differences in the display areas of A, B and C driven by the respective gate driving devices 51 on the LCD panel, so-called block dim phenomenon,

### BRIEF SUMMARY OF THE INVENTION

Accordingly, the present invention is designed to solve the above described problem and an object of the present invention is to provide an LCD panel driving device that readily eliminates the block dim phenomenon by a simple method.

Besides, another object of the present invention is to provide conductive patterns of the LCD panel that efficiently couple the LCD driving devices and the lower glass of the LCD panel.

To accomplish the above object in accordance with a first aspect of the present invention, there is provided an LCD driving device connected electrically with conductive patterns formed on a lower glass of an LCD panel and outputting driving signals for driving the LCD panel based on driving signals input from the conductive patterns, the LCD driving device comprising: a plurality of first input bumps for inputting driving signals; and a plurality of second input bumps coupled electrically with the first input bumps, respectively, at least two of the first input bumps being connected with each other via resistors each having a resistance value different from each other.

Also, to accomplish the above object in accordance with a second aspect of the present invention, there is provided An LCD driving device connected electrically with conductive patterns formed on a lower glass of an LCD and outputting driving signals for driving the LCD panel based on driving signals input from the conductive patterns, the LCD driving device comprising: a plurality of first input bumps for inputting driving signals; and a plurality of second input bumps coupled electrically with the first input bumps, respectively, at lest two of the first input bumps being assigned for a single driving signal input and connected with each other in parallel via resistors each having a resistance value different from each other.

In addition, the resistance values of the resistors connected with the first input bumps are set to integer times of the resistance value that the conductive pattern of the lower glass has.

Besides, the first input bumps connected with the resistors are input bumps for gate driving signals of the LCD panel.

Moreover, the LCD driving device is mounted on a base film and connected with the conductive pattern of the lower glass via conductive pattern formed on the base film.

Furthermore, to accomplish the above object in accordance with a third aspect of the present invention, there is provided, in an LCD module including a plurality of LCD driving devices connected to a lower glass of an LCD panel and a conductive pattern, formed on the lower glass of the LCD panel, for applying driving signals to the LCD driving devices, the conductive pattern being configured so that at least one driving signal is applied to the LCD driving devices via a different signal input end, respectively.

In addition, the conductive pattern described above further comprises a dummy pattern connected in parallel with corresponding conductive pattern.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a configuration diagram showing a general module of a TFT LCD;

FIG. 2 is a configuration diagram concretely illustrating how base films 5 and a lower glass 1 are connected, each base film 5 having a gate driving device 51 of FIG. 1;

FIG. 3 is a configuration diagram illustrating an active matrix circuit and a driving circuit constituting an LCD panel;

FIGS. 4 and 5 show an exemplary diagram of output circuits of the gate driving devices 51 for outputting gate driving signals;

FIG. 6 is a configuration diagram depicting a driving signal input circuit of the LCD driving device in accordance with a preferred embodiment of the invention;

FIG. 7 is a configuration diagram illustrating an example of a main part of the LCD panel configured by using the gate driving devices 100 shown in FIG. 6; and

FIG. 8 is a configuration diagram showing another example of a main part of the LCD panel configured by using the gate driving devices 100 shown in FIG. 6.

### DETAILED DESCRIPTION OF THE INVENTION

Reference will now be made in detail to the preferred embodiments of the present invention, examples of which are illustrated in the accompanying drawings.

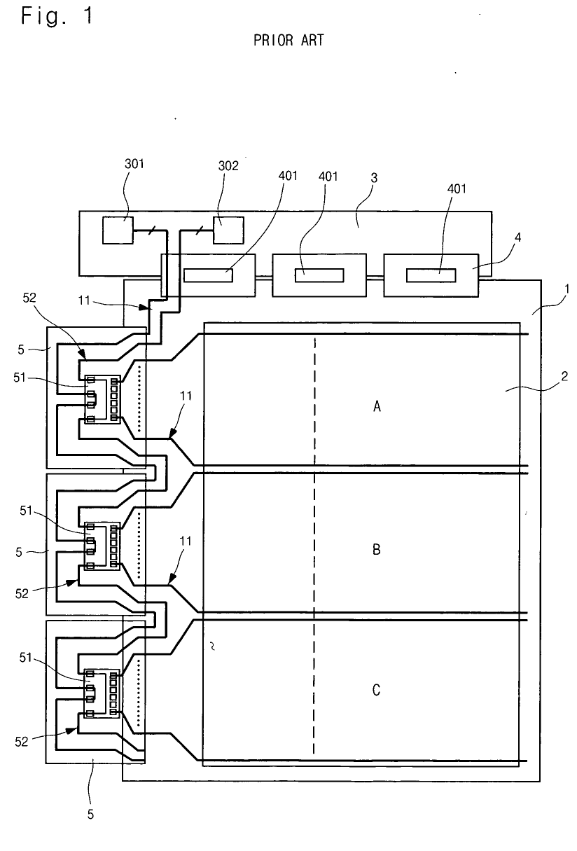

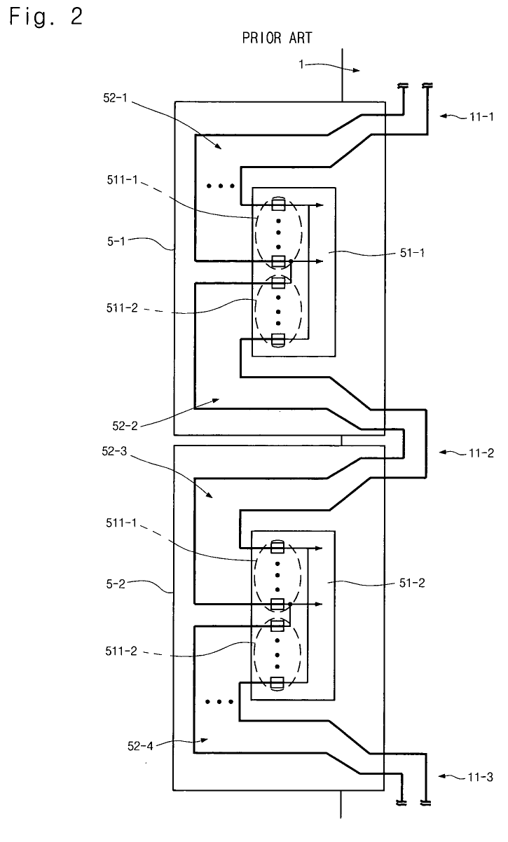

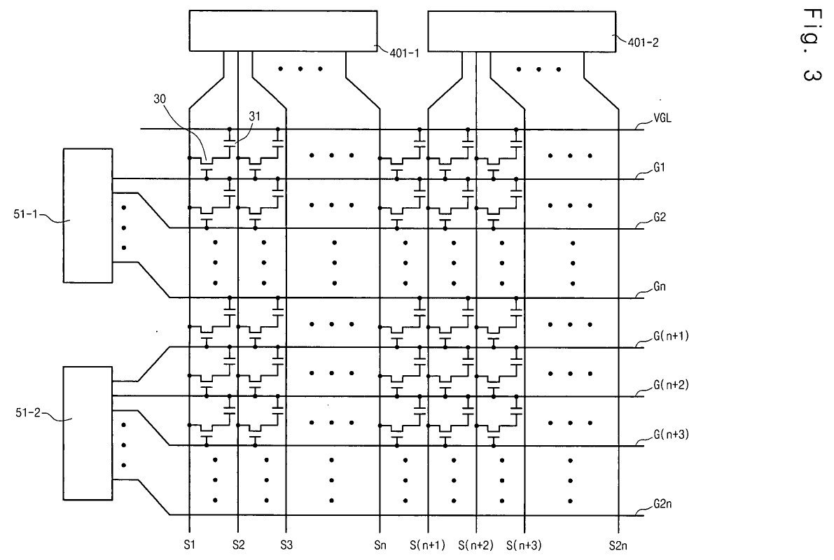

FIG. 3 is a configuration diagram illustrating an active matrix circuit and a driving circuit constituting an LCD panel. Like reference numerals denote like elements of FIGS. 1 and 2. A plurality of data lines S (S1, S2, . . . , Sn) and a plurality of gate lines G (G1, G2, . . . , Sn) are arranged crossed with each other as a matrix pattern on a lower glass of the LCD panel. On each of crossings, an FET 30 and a capacitor 31 are arranged to drive corresponding pixel of the LCD panel.

The gate lines G are connected with gate driving devices 51 (51-1 and 51-2) for driving the gate lines G and the data lines S are coupled with data driving devices 401 (401-1 and 401-2) for outputting gradation signals. That is, the gate lines (G1, G2, . . . , Gn) are connected with a first gate driving device 51-1 and the gate lines (G(n+1), G(n+2), . . . , G2n) are coupled with a second gate driving device 51-2. The data lines (S1, S2, . . . , Sn) are connected with a first data driving device 401-1 and the data lines (S(n+1), S(n+2), . . . , S2n) are coupled with a second data driving device 401-2. Although only two gate driving devices 51 and two data driving devices 401 are depicted in the figure, the number of devices 51 and 401 will be varied according to the size of the LCD panel.

The gate driving device 51 selectively drives the gate lines in order and the data driving device 401 outputs gradation signals corresponding to the selected pixels.

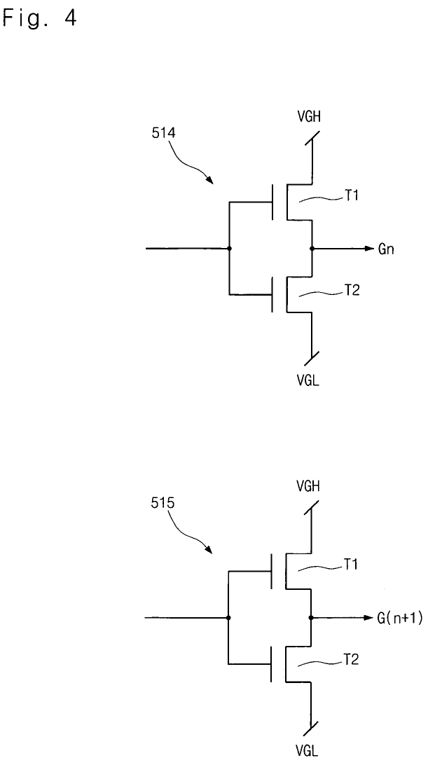

FIG. 4 shows examples of output circuits of the gate driving device 51, wherein an output circuit 514 drives n^{th} gate line and an output circuit 515 drives n+1^{th} gate line.

The gate driving signal output circuit includes an N-channel type FET (T1) and a P-channel type FET (T2) connected in series with each other. A drain of the N-channel type FET (T1) is connected with a VGH of +20V and a drain of the P-channel type FET (T2) is coupled with a VGL of −5V for example. The VGH and VGL are applied in order from the printed circuit board 3 shown in FIG. 1 to the gate driving devices 51. Sources of the FETs (T1) and (T2) are coupled with each other and the node is connected electrically with the gate line G. Gates of the FETs (T1) and (T2) are coupled with each other and connected to an internal circuit of the gate driving device 51.

In the gate driving signal output circuits 514 and 515, when a driving data of high level is input from the internal circuit, the N-channel type FET (T1) is turned on, the P-channel type FET (T2) is turned off and the VGH of +20V is applied to the gate line as a gate driving signal. When a driving data of low level is input from the internal circuit, the N-channel type FET (T1) is turned off, the P-channel type FET (T2) is turned on and the VGL of −5V is applied to the gate line as a gate driving signal.

When the gate driving signal of +20V is output from the gate driving device 51, the FET 30 connected with the gate line corresponding to the driving signal is turned on to store a gradation signal output from the data driving device 51 via the data line in the capacitor 31. An end of the capacitor 31 is connected with the source of FET 30 and the other end of the capacitor 31 is coupled with the gate line G. Here, the gate line connected with the gate of FET 30 is not the one coupled with the capacitor 31. That is, if the gate line connected with FET 30 is the n^{th} gate line, the capacitor 31 is coupled with the (n−1)^{th} gate line. Accordingly, if the gate line connected with the gate of FET 30 is being driven with the VGH, i.e., the driving signal of +20V, the gate line coupled with the capacitor 31 is driven with VGL, i.e., the driving signal of −5V. Consequently, the level of the gradation signal charged in the capacitor 31 is set to an electric potential based on the VGL, i.e., −5V.

Meanwhile, referring back to FIG. 3, since the gate lines (G1, G2, . . . , Gn) are all driven by the first gate driving device 51-1, the VGH and VGL applied to the respective gate lines G (G1, G2, . . . , Gn) are set to same voltage levels. Also, since the gate lines (G(n+1), G(n+2), . . . , G2n) are all driven by the second gate driving device 51-2, the VGH and VGL applied to the respective gate lines (G(n+1), G(n+2), . . . , G2n) are set to same voltage levels.

However, as described with reference to FIGS. 1 and 2, the driving power source input to the second gate driving device 51-2 is applied from the first driving device 51-1. The driving power source output from the first gate driving device 51-1 is input to the second gate driving device 51-2 via the second conductive pattern 52-2 on the base film 5-1, the conductive pattern 11-2 on the lower glass 1 and the first conductive pattern 52-3 on the base film 5-2, in turn. The conductive pattern 52 on the base film 5 has about 0.5 Ω, a negligible resistance, against the line width of 25 μm. However, the conductive pattern 11 formed on the lower glass 1 has about 50 Ω, a considerable resistance.

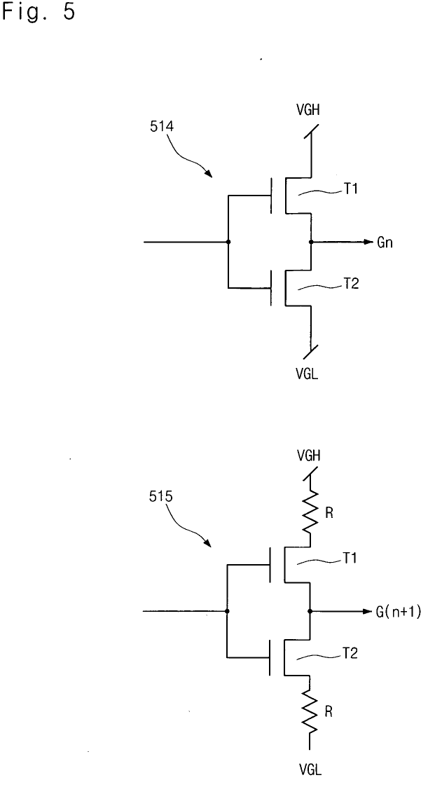

FIG. 5 shows circuit diagrams equivalently illustrating output circuits of the gate driving devices 51 in consideration of the sheet resistance of the conductive pattern 11. Like reference numerals denote like elements of FIG. 4.

The output circuit 514 driven by the first gate driving device 51-1 has the same configuration as that of FIG. 4. However, in case of the output circuit 515 driven by the second gate driving device 51-2, it is considered that each of drain ends of FETs (T1) and (T2) is configured to connect a specific resistor R. The resistor R corresponds to the sheet resistance of the conductive pattern 11 formed on the lower glass 1.

In the output circuit 515, since the VGH turns on and off FETs 30 disposed on the respective pixels, it does not affect the image quality of the LCD panel. However, since the VGL is applied as a reference potential for the capacitors 31 provided on the respective pixels, adding the resistor R fluctuates the reference electric potential of the capacitors 31. By adding the resistor R, the electric potentials of VGL output from the first and second gate driving devices 51-1 and 51-2 are set to be different from each other. That is, the reference electric potential of the gate lines (G1, G2, . . . , Gn) driven by the first gate driving device 51-1 is set to be different from that of the gate lines (G(n+1), G(n+2), . . . , G2n) driven by the second gate driving device 51-2. Accordingly, the screen gradations on the LCD panel output by the same gradation signal have different presentations from the regions of the gate lines (G1, G2, . . . , Gn) and (G(n+1), G(n+2), . . . , G2n), respectively, which results in a block dim phenomenon.

The above-described problem occurs over all LCD driving devices cascaded through the conductive pattern 11 on the lower glass 1, not limited to the first and second gate driving devices 51-1 and 51-2.

The present invention is directed to remove the block dim phenomenon by setting the driving power source input to all cascaded LCD driving devices to a same level. While the present invention can be applied to all driving power sources for driving the LCD panel, description will be made hereinafter only as for the VGL for the sake of brevity.

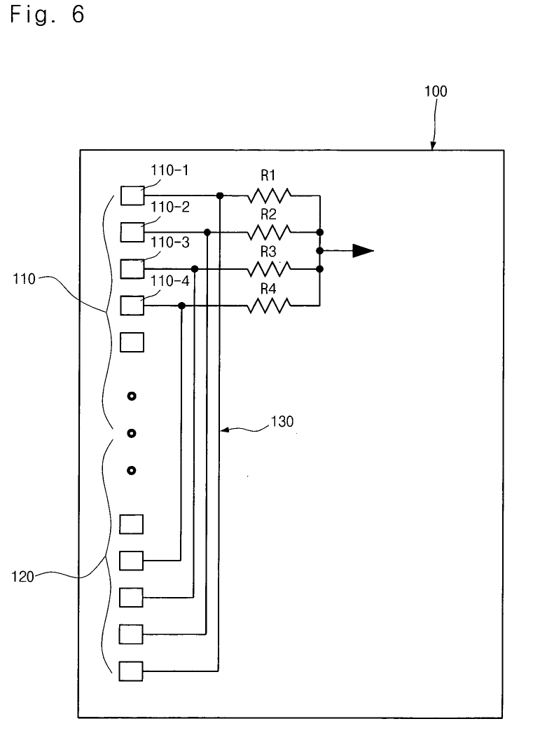

FIG. 6 shows a configuration of a main part of a gate driving device 100 in accordance with a preferred embodiment of the invention. The gate driving device 100 include a first input bump 110 for inputting driving signals applied from the lower glass 1 and a second input bump 120 for outputting the driving signals from the first input bump 110 to a following gate driving device, as same as the conventional one. The first and second input bumps 110 and 120 are coupled electrically with each other via metal lines 130. Also, the first and second input bumps 110 and 120 will be connected electrically with the conductive pattern on the base film, in which the gate driving device 100 is mounted.

Meanwhile, in the present embodiment of the invention, four input bumps 110-1 to 110-4 are assigned to input one driving signal, e.g., VGL signal. The input bumps 110-1 to 110-4 are coupled with each other in parallel via resistors R1 to R4 and the signal applied to the node is input to an internal circuit as the VGL signal.

The values of the resistors R1 to R4 are set based on the sheet resistance value of the conductive patterns formed on the lower glass. For example, if the sheet resistance value is “R”, the values of the resistors R1 to R4 are set to integer times of the sheet resistance value, such as “R”, “2R”, “3R”, and “4R”, respectively.

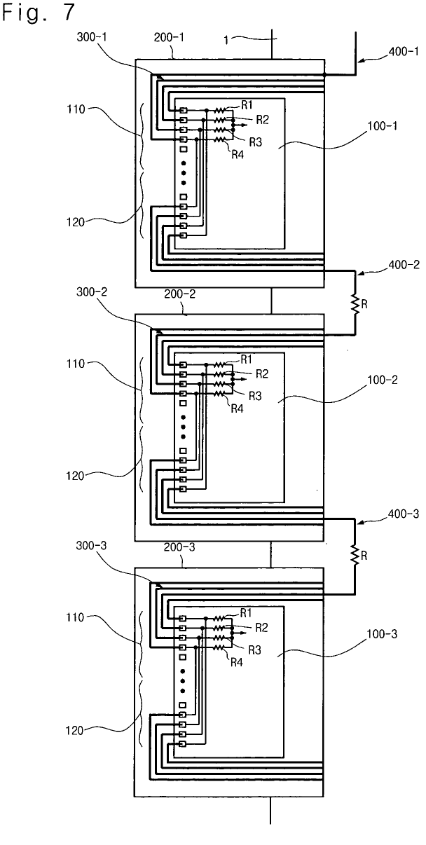

FIG. 7 is a configuration diagram illustrating an example of a main part of the LCD panel configured by using the gate driving devices 100 shown in FIG. 6. In the figure, three gate driving devices 100 are provided. The number of gate driving devices 100 varies according to the size of the LCD panel. Also, like reference numerals denote like elements of FIG. 6.

In FIG. 7, the gate driving devices 100 (100-1, 100-2 and 100-3) are mounted on base films 200 (200-1, 200-2 and 200-3) in a flip chip method. Specific conductive patterns 300 (300-1, 300-2 and 300-3) are arranged on the base films 200. Each one end of the conductive patterns 300 is connected electrically with the input bump 110 or 120 and the other ends are arranged extended to the end being in contact with the lower glass 1. In FIG. 7, the conductive patterns 300 are depicted to input only one driving signal, e.g., VGL signal, the conductive patterns for inputting the other driving signals are omitted for the sake of brevity. Here, the first to third gate driving devices 100-1, 100-2 and 100-3 and the first to third base films 200-1, 200-2 and 200-3 have the same configurations, respectively.

Meanwhile, conducive patterns 400 (400-1, 400-2 and 400-3) connected electrically with the conductive patterns 300 on the base films 200 are arranged on the lower glass 1. Here, the resistor R depicted on the conductive patterns 400 denotes an equivalent sheet resistance of the conductive patterns 400. The first conductive pattern 400-1 on the lower glass 1 is to connect a driving signal, e.g., VGL signal, output from the printed circuit board 30 of FIG. 1 to the first base film 200-1; the second conductive pattern 400-2 is to forward the driving signal output from the first base film 200-1 to the second base film 200-2; and the third conductive pattern 400-3 is to deliver the driving signal output from the second base film 200-2 to the third base film 200-3.

The conductive pattern 400 formed on the lower glass 1 is connected selectively with one of the plural conductive patterns 300 mounted on the base film 200. Here, the connection configuration made between the conductive pattern 400 on the lower glass 1 and the conductive patterns 300 on the base film 200 will be varied according to the location of corresponding base film 200 established. The driving signal applied to the base film 200 via the conductive pattern 400 on the lower glass 1 is connected to the first input bump 110 of the gate driving device 100 via a specific conductive pattern 300. Then, the driving signal input from the first input bump 110 is applied to the second input bump 120 and to the internal circuit via the resistors R1 to R4 coupled with corresponding input bumps 110, respectively. As described above in detail, the resistors R1 to R4 have different values from one another and the values of the resistors R1 to R4 are set to integer times of the resistance value the conductive pattern 400 on the lower glass 1 has, such as “R”, “2R”, “3R”, and “4R”, respectively.

In the above-described configuration, the connected locations between the conductive patterns 400 on the lower glass 1 and the conductive patterns 300 on the base film 200 are varied according to the locations of the base film 200s. That is, each of the gate driving devices 100 inputs the driving signal to the internal circuit via the resistors R1 to R4 each having a different resistance. Accordingly, in consideration of the resistance value R on the lower glass 1 connecting the base films 200, the location of the conductive pattern 400 formed on the lower glass 1 is set so that the base film 200 positioned adjacent to the driving signal applied from the printed circuit board can receive the driving signal via one of the resistors R1 to R4, the one having a larger resistance value.

Taking the third gate driving device 100-3 of FIG. 7 into consideration, the driving signal applied to the third gate driving device 100-3 travels via the first and second base films 200-1 and 200-2 and the second and third conductive patterns 400-2 and 400-3 on the lower glass 1. Accordingly, when neglecting the resistance values by the conductive patterns 300-1 and 300-2 formed on the first and second base films 200-1 and 200-2, there exists a resistance value of “2R”, which adds the resistance values of the conductive patterns 400-1 and 400-2, on the signal path of the driving signal input to the third gate driving device 100-3. Then, since the driving signal input to the third gate driving device 100-3 is applied to the internal circuit via the resistor R2 having the resistance value of “2R”, there exists a total resistance value of “4R” on the signal path of the driving signal input to the internal circuit of the third gate driving device 100-3.

The driving signal applied to the second gate driving device 100-2 travels via the first base film 200-1 and the second conductive pattern 400-2 on the lower glass 1. Accordingly, there exists the resistance value of “R” by the second conductive pattern 400-2 on the signal path of the driving signal. Besides, since the driving signal input to the second gate driving device 100-2 is applied to the internal circuit via the resistor R3 having a resistance value of “3R”, there exists a total resistance value of “4R” on the signal path of the driving signal input to the internal circuit of the second gate driving device 100-2.

The driving signal applied to the first gate driving device 100-1 is input directly via the first conductive pattern 400-1 on the lower glass. Since the driving signal input to the first gate driving device 100-1 is applied to the internal circuit via the resistor R4 having a resistance value of “4R”, there exists a total resistance value of “4R” on the signal path of the driving signal input to the internal circuit of the first gate driving device 100-1.

Consequently, there exists the same resistance value of “4R” on the signal paths of the driving signals input to the internal circuits of the first to third gate driving devices 100-1 to 100-3. Accordingly, the driving signals input to the first to third gate driving devices 100-1 to 100-3 are set to have the same level, thus removing the block dim phenomenon generated by the level difference of the driving signals.

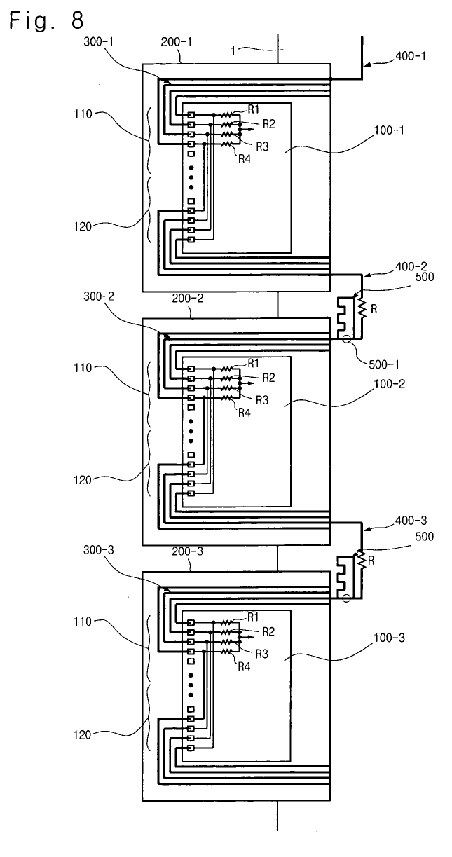

Meanwhile, FIG. 8 is a configuration diagram showing another example of a main part of the LCD panel configured by using the gate driving devices 100 shown in FIG. 6. Also, like reference numerals denote like elements of FIG. 7.

In FIG. 8, a specific dummy pattern 500 is formed against the conductive patterns 400 on the lower glass 1. As described above in detail, the resistors R1 to R4 connected with the input ends of the gate driving device 100 are set desirably to integer times of the resistance value “R” the conductive pattern 400 on the lower glass 1 have. As the resistors R1 to R4 are fixedly set in fabricating corresponding device, it is difficult to change the resistance values thereafter. Unlike this, the conductive patterns 400 formed on the lower glass 1 may have changeable resistance values due to modifications in design and fabrication.

In the embodiment of FIG. 8, the dummy patterns 500 are provided in parallel with the conductive patterns 400. The interconnection 500-1 of the conductive pattern 400 connected with the dummy pattern 500 in parallel is eliminated by using a laser trimming technique, for example, to modify the length of the conductive pattern 400, thus varying the resistance value the conductive pattern 400 has.

Although the present invention has been described with reference to certain exemplary embodiments thereof, changes may be made to the described embodiments without departing from the scope of the present invention.

For example, the above-described embodiments are directed to the case that the present invention is applied to VGL signal for the gate driving device. However, the invention can be applied in the same manner to any other driving signals, of which levels may fluctuate.

According to the present invention as described above, it is possible to remove the LCD panel block dim phenomenon readily by modifying partially the configuration of the driving signal input ends of the LCD panel driving device and by varying the connection method of the LCD panel driving device and the lower glass of the LCD panel.

1. An LCD driving device connected electrically with conductive patterns formed on a lower glass of an LCD panel and outputting driving signals for driving the LCD panel based on driving signals input from the conductive patterns, the LCD driving device comprising:
a plurality of first input bumps for inputting driving signals; and
a plurality of second input bumps coupled electrically with the first input bumps, respectively,
at least two of the first input bumps being connected with each other via resistors each having a resistance value different from each other.

2. The LCD driving device as recited in claim 1, wherein the resistance values of the resistors connected with the first input bumps are set to integer times of the resistance value that the conductive pattern of the lower glass has.

3. The LCD driving device as recited in claim 1, wherein the first input bumps connected with the resistors are input bumps for gate driving signals of the LCD panel.

4. The LCD driving device as recited in claim 1, wherein the LCD driving device is mounted on a base film and connected with the conductive pattern of the lower glass via conductive pattern formed on the base film.

5. An LCD driving device connected electrically with conductive patterns formed on a lower glass of an LCD and outputting driving signals for driving the LCD panel based on driving signals input from the conductive patterns, the LCD driving device comprising:
a plurality of first input bumps for inputting driving signals; and
a plurality of second input bumps coupled electrically with the first input bumps, respectively,
at lest two of the first input bumps being assigned for a single driving signal input and connected with each other in parallel via resistors each having a resistance value different from each other.

6. In an LCD module including a plurality of LCD driving devices connected to a lower glass of an LCD panel and a conductive pattern, formed on the lower glass of the LCD panel, for applying driving signals to the LCD driving devices,
the conductive pattern being configured so that at least one driving signal is applied to the LCD driving devices via a different signal input end, respectively.

7. The conductive pattern as recited in claim 6 further comprising:
a dummy pattern connected in parallel with corresponding conductive pattern.
